(19) United States
(12) Patent Application Publication
(10) Pub. No.: US 2019/0111654 A1
(43) Pub. Date: Apr. 18, 2019

(54) VEGETABLE FIBER-CONTAINING BOARD AND METHOD FOR PRODUCING THE SAME

(71) Applicant: TOYOTA BOSHOKU KABUSHIKI KAISHA, Aichi (JP)

(72) Inventors: Yuki IZAWA, Aichi (JP); Yasuhiro UEDA, Aichi (JP)

(73) Assignee: TOYOTA BOSHOKU KABUSHIKI KAISHA, Aichi (JP)

(21) Appl. No.: 16/156,230

(22) Filed: Oct. 10, 2018

(30) Foreign Application Priority Data
Oct. 18, 2017 (JP) 2017-202192

(51) Int. Cl. B32B 5/02; B32B 7/12; B32B 27/12; B32B 27/32; B32B 37/15

(52) U.S. Cl. CPC B32B 5/022; B32B 7/12; B32B 27/12; B32B 27/32; B32B 2605/003; B32B 2260/021; B32B 2260/046; B32B 2262/06; B32B 37/15

(57) ABSTRACT

The present invention is directed to a method for producing a vegetable fiber-containing board, including a press molding step of heating and pressing a fiber mat which includes vegetable fibers and a thermoplastic resin fiber containing a thermoplastic resin, from both the front and back sides, at a temperature at which the thermoplastic resin fiber melts, wherein the thermoplastic resin contains an acid-modified thermoplastic resin having an acid modification degree of 0.03 to 0.09.

### BACKGROUND OF THE INVENTION

### (1) Field of the Invention

The present invention relates to a method for efficiently producing a vegetable fiber-containing board including vegetable fibers bonded to each other with a thermoplastic resin.

### (2) Description of Related Art

In recent years, a substrate for a part to be installed in the interior of an automobile is produced by using as a precursor a plate-shaped vegetable fiber-containing board including vegetable fibers bonded to each other with a thermoplastic resin, because of being excellent in cost, moldability, etc., and shaping the board by means of a die having a cavity having a predetermined shape. In order to further reduce the weight of such a substrate and improve the rigidity, studies have been made on the proportion of the vegetable fibers contained in the vegetable fiber-containing board, the kind of the thermoplastic resin, and the like. For example, in JP 2009-234129 A, in order to produce a vegetable fiber composite material (vegetable fiber-containing board), kenaf fibers are used as vegetable fibers, and an acid-modified polyolefin having an acid value of 5 or more, which is excellent in adhesiveness to the kenaf fibers, is used as a thermoplastic resin.

Further, as a method for producing a vegetable fiber-containing board, for example, JP 2006-95918 A discloses a method for producing a fiber board composed of a thermoplastic resin and a fibrous substance, the method including a first step of forming a mixed mat in which the amount of the thermoplastic resin to be mixed with the fibrous substance on at least one surface of the mixed mat is larger than the amount of the thermoplastic resin to be mixed therewith inside the mixed mat, and a second step of continuously heating and pressing the mixed mat while conveying the mixed mat by means of conveyers, wherein the second step involves passing the mixed mat between a pair of opposite conveyors equipped with a heating device for transferring heat to the conveyor surfaces to heat and press the thermoplastic resin in the mixed mat to a temperature equal to or higher than the softening point, and further maintaining the state of contact between the conveyors and the mixed mat until the thermoplastic resin is cooled to a temperature equal to or lower than the softening point. Furthermore, JP 2014-237235 A discloses a method for producing a fibrous molded body having a structure in which vegetable fibers are bonded, the method including a melting and solidifying step of melting and then solidifying a sheath portion of a thermoplastic resin fiber having a core/sheath structure while pressing a fiber mat which includes vegetable fibers and the thermoplastic resin fiber from both the front and back sides, wherein the thermoplastic resin fiber has a core portion formed of a first thermoplastic resin and the sheath portion formed of a second thermoplastic resin, the first thermoplastic resin includes a modified thermoplastic resin, and the second thermoplastic resin is a non-modified thermoplastic resin having a melting point lower than that of the first thermoplastic resin.

### SUMMARY OF INVENTION

When vegetable fiber-containing boards are produced as described above, a uniform thickness is finally attained by hot-pressing the mixed mat (JP 2006-95918 A) or melting and solidifying the fiber mat (JP 2014-237235 A). However, when a modified type thermoplastic resin is used in the preparation of the mixed mat, there has occurred the defect that a fiber mat compressed material sticks to metallic hot plates (press members) due to the melt at the time of hot-pressing, thereby causing the problems that a vegetable fiber-containing board having a stable composition cannot be obtained and that the productivity thereof is reduced. So, there have been taken measures of supplying release sheets made of a fluororesin to surfaces of the hot plates on both sides and hot-pressing the fiber mat in a state where the fiber mat is sandwiched between the two release sheets. However, such a production method using release sheets does not completely overcome the above-mentioned defect, and it is necessary to replace the release sheets after the production of a certain amount of vegetable fiber-containing boards. The release sheets are difficult to reuse, and, besides, the operation of the producing apparatus has to be stopped when the release sheets are replaced. Therefore, the cost and productivity are still not sufficient.

An object of the present invention is to provide a method for efficiently producing a vegetable fiber-containing board having a stable composition, without disposing release sheets on both sides of a fiber mat that includes vegetable fibers and a fiber containing an acid-modified thermoplastic resin, in the production of vegetable fiber-containing boards by hot-pressing the fiber mat from both the front and back sides. Another object of the present invention is to provide a vegetable fiber-containing board which gives a molded body having excellent rigidity, as a substrate for an interior material or the like, and an interior material including a base portion composed of a substrate for an interior material.

It is said to be preferable to use a thermoplastic resin having a high modification degree when vegetable fibers are bonded to each other. For example, an acid-modified polyolefin having an acid modification degree of 2.3 has been used. The present inventors have studied whether or not sufficient performance can be obtained for a thermoplastic resin having a lower acid modification degree. The present inventors have found that, in a method for producing a vegetable fiber-containing board including a plurality of vegetable fibers bonded to each other with a thermoplastic resin, a fiber mat that includes vegetable fibers and a thermoplastic resin fiber containing an acid-modified thermoplastic resin having an acid modification degree of 0.03 to 0.09 is subjected to hot-pressing, thereby providing not only a vegetable fiber-containing board having a stable composition without the fiber mat sticking to hot plates and without impairing the raw material composition, but also a vegetable fiber-containing board which gives a molded body having excellent rigidity. The present invention is indicated below.
1. A method for producing a vegetable fiber-containing board comprising a plurality of vegetable fibers bonded to each other with a thermoplastic resin, the method comprising

a press molding step of heating and pressing a fiber mat which comprises vegetable fibers and a thermoplastic resin fiber containing a thermoplastic resin, from both the front and back sides, at a temperature at which the thermoplastic resin fiber melts,

wherein the thermoplastic resin contains an acid-modified thermoplastic resin having an acid modification degree of 0.03 to 0.09.
2. The method for producing a vegetable fiber-containing board according to item 1, wherein the acid-modified thermoplastic resin includes an acid-modified polyolefin resin.
3. A vegetable fiber-containing board comprising vegetable fibers and a thermoplastic resin bonding the vegetable fibers to each other,

wherein the thermoplastic resin contains an acid-modified thermoplastic resin having an acid modification degree of 0.03 to 0.09.
4. A method for producing a substrate for an interior material, comprising the step of shaping the vegetable fiber-containing board according to item 3.
5. An interior material comprising a base portion composed of a substrate for an interior material obtained by the method according to item 4 and a skin layer disposed on a surface of the base portion.

The present invention enables efficient production of a vegetable fiber-containing board having a stable composition without using a release sheet. In the press molding step, for example, it is possible to use a double belt press device having a press portion having a length of several tens of meters. At the time of hot-pressing, the molten resin contained in the heated fiber mat does not stick to press members such as hot plates, and thus it is possible to produce, with high productivity, a vegetable fiber-containing board containing an acid-modified thermoplastic resin in the expected proportion.

The vegetable fiber-containing board of the present invention has excellent rigidity as compared with those containing an acid-modified thermoplastic resin having an acid modification degree of less than 0.03 and those containing an acid-modified thermoplastic resin having an acid modification degree exceeding 0.09. Further, a substrate for an interior material having excellent rigidity can be obtained by shaping the vegetable fiber-containing board of the present invention through die molding. Incidentally, the vegetable fiber-containing board of the present invention usually has a plate shape, and can be used, as it is, as a substrate for an interior material.

### BRIEF DESCRIPTION OF THE DRAWINGS

The present invention will be further described in the detailed description which follows, with reference to the noted plurality of drawings by way of non-limiting examples of exemplary embodiments of the present invention, in which like reference numerals represent similar parts throughout the several views of the drawings.

FIG. 1 is a schematic diagram showing an example of an apparatus for producing a vegetable fiber-containing board according to the present invention; and

FIG. 2 is a graph for comparing the rigidity of a vegetable fiber-containing board obtained in Experimental Example 8 and the rigidity of a vegetable fiber-containing board obtained in Experimental Example 9 with each other.

### DETAILED DESCRIPTION OF PREFERRED EMBODIMENTS

The particulars described herein are given by way of example and for the purpose of illustrative discussion of the embodiments of the present invention, and are presented for the purpose of providing what is believed to be the description from which the principles and conceptual features of the present invention can be most effectively and readily understood. In this regard, it is not intended to show structural details of the present invention in more detail than is necessary for the fundamental understanding of the present invention, and the description is taken with the drawings making apparent to those skilled in the art how several forms of the present invention may be embodied in practice.

Hereinafter, the present invention will be described in detail.

The present invention is directed to a method for producing a vegetable fiber-containing board including a plurality of vegetable fibers bonded to each other with a thermoplastic resin, the method including a press molding step of heating and pressing a fiber mat that includes vegetable fibers and a fiber (hereinafter referred to as “thermoplastic resin fiber (F1)”) containing a thermoplastic resin (hereinafter referred to as “thermoplastic resin (R1)”), from both the front and back sides, at a temperature at which the thermoplastic resin fiber (F1) melts, wherein the thermoplastic resin (R1) includes an acid-modified thermoplastic resin (hereinafter referred to as “acid-modified thermoplastic resin (R1-1)”) having an acid modification degree of 0.03 to 0.09.

The fiber mat contains at least vegetable fibers and a thermoplastic resin fiber (F1), and may contain other fibers according to need.

The vegetable fibers contained in the fiber mat are fibers derived from a trunk, a stem, a branch, a leaf, a root, and the like of a plant, and are linear fibrous bodies derived from vegetable fibers of kenaf, jute hemp, manila hemp, sisal hemp, gampi (Diplomorpha sikokiana), mitsumata (Edgeworthia papyrifera), kozo (paper mulberry), banana, pineapple, coconut, corn, sugar cane, bagasse, palm, papyrus, reed, esparto, sabai grass, wheat, rice, bamboo, conifers (cedar, cypress, etc.), broad-leaved trees, cotton, and the like. Among these, preferred are linear fibrous bodies (kenaf fibers) derived from kenaf as a plant in the Malvaceae family which is an annual grass having woody stems and glowing very fast, and having excellent carbon dioxide absorption and contributing to reduction in amount of carbon dioxide in the atmosphere, effective utilization of forest resources, etc. Examples of the kenaf include Hibiscus cannabinus and Hibiscus sabdariffa in scientific names, and koma, Cuban kenaf, yoma, Thai kenaf, mesta, bimli, ambari hemp and Bombay hemp in common names.

The fiber length and fiber diameter of the vegetable fibers are not particularly limited. The fiber length is preferably 10 to 150 mm, and the fiber diameter is preferably 0.01 to 1 mm. The fiber length and fiber diameter are values calculated by measuring the distance between two points with an optical microscope (microscope) or the like.

Furthermore, the average fiber length of the vegetable fibers is also not particularly limited. From the viewpoint of rigidity, the average fiber length is preferably 30 to 80 mm. The average fiber length is an average value of the fiber lengths of 200 randomly selected vegetable fibers, in total, obtained by measuring the distance between two points with an optical microscope (microscope).

From the viewpoint of the rigidity of the molded body obtained by molding (shaping) the vegetable fiber-containing board, the proportion of the vegetable fibers contained in the fiber mat is preferably 20 to 70% by mass, more preferably 30 to 65% by mass, further preferably 40 to 60% by mass based on the entire fiber mat.

The thermoplastic resin fiber (F1) is a fiber containing a thermoplastic resin (R1) including an acid-modified thermoplastic resin (R1-1), which melts in the press molding step. The thermoplastic resin (R1) may be composed only of the acid-modified thermoplastic resin (R1-1), or may be composed of the acid-modified thermoplastic resin (R1-1) and an acid-unmodified thermoplastic resin (hereinafter referred to as “thermoplastic resin (R1-2)”). That is, the thermoplastic resin fiber (F1) may be composed only of the acid-modified thermoplastic resin (R1-1), or may be composed of the acid-modified thermoplastic resin (R1-1) and the acid-unmodified thermoplastic resin (R1-2). In both of these embodiments, the thermoplastic resin fiber (F1) can contain various additives.

The acid-modified thermoplastic resin (R1-1) is a homopolymer or copolymer including at least one of a structural unit derived from an unsaturated monomer having a carboxyl group and a structural unit derived from an unsaturated monomer having an acid anhydride group. Examples of the unsaturated monomer having a carboxyl group include acrylic acid, methacrylic acid, ethacrylic acid, maleic acid, fumaric acid, itaconic acid, crotonic acid, and cinnamic acid. Examples of the unsaturated monomer having an acid anhydride group include maleic anhydride, itaconic anhydride, citraconic anhydride, and 2,3-dimethyl maleic anhydride.

The base resin of the acid-modified thermoplastic resin (R1-1) is preferably a polyolefin resin, and examples thereof include polyethylene, polypropylene, ethylene/propylene copolymers, ethylene/1-butene copolymers, ethylene/1-pentene copolymers, ethylene/1-hexene copolymers, ethylene/1-heptene copolymers, and ethylene/1-octene copolymers. Among these, polypropylene is preferred.

As the acid-modified thermoplastic resin (R1-1), a polyolefin resin modified with maleic anhydride or maleic acid is preferred, and a resin in which a (co) polymer including a propylene unit is modified with maleic anhydride is particularly preferred.

The acid modification degree of the acid-modified thermoplastic resin (R1-1) is 0.03 to 0.09, preferably 0.04 to 0.08 from the viewpoint of being capable of suppressing the defects in the press molding step, and the rigidity of the molded body obtained by molding (shaping) the vegetable fiber-containing board. Incidentally, this acid modification degree can be obtained from the infrared spectrum.

For example, the acid modification degree of the acid-modified polypropylene can be obtained from the intensity ratio between the C—C absorption peak derived from polypropylene (840 cm⁻¹) and the C═0 absorption peak derived from the modified product (1785 cm⁻¹), after obtainment of the infrared absorption spectrum by FT-IR. When the absorption intensity at 840 cm⁻¹ is 0.916 and the absorption intensity at 1785 cm⁻¹ is 0.0825, the acid modification degree is 0.0825/0.916=0.090.

The proportion of the acid-modified thermoplastic resin (R1-1) contained in the fiber mat is preferably from 2 to 20 parts by mass, more preferably from 2.5 to 12 parts by mass, still more preferably from 3 to 8 parts by mass, when the content of the vegetable fibers is 100 parts by mass, from the viewpoint of the rigidity of the molded body obtained by molding (shaping) the vegetable fiber-containing board.

As described above, the thermoplastic resin fiber (F1) may be a fiber composed of the acid-modified thermoplastic resin (R1-1) and the acid-unmodified thermoplastic resin (R1-2). In this case, the content proportions of these resins are not particularly limited, but are preferably 1 to 30% by mass and 70 to 99% by mass, more preferably 3 to 15% by mass and 85 to 97% by mass, respectively, when the total content of these resins is 100% by mass. In addition, in the above case, the acid-unmodified thermoplastic resin (R1-2) can be a non-modified thermoplastic resin such as a polyolefin resin, an aromatic vinyl resin, an acrylic resin or a polyacetal resin, or a thermoplastic resin obtained by modifying these resins with a hydroxyl group, an amino group, an epoxy group, or the like. However, the acid-unmodified thermoplastic resin (R1-2) is preferably the same resin or the same kind of resin as the base resin of the acid-modified thermoplastic resin (R1-1). For example, when the acid-modified thermoplastic resin (R1-1) is an acid-modified polyolefin resin, the thermoplastic resin (R1-2) used in combination is preferably an acid-unmodified polyolefin resin.

The fiber length and fiber diameter of the thermoplastic resin fiber (F1) are not particularly limited. The fiber length is preferably 10 mm or more, and the fiber diameter is preferably 1 to 100 dtex, for example, from the viewpoint of the shape retention of the fiber mat. The average fiber length of the thermoplastic resin fiber (F1) is preferably 10 to 150 mm, more preferably 20 to 100 mm, particularly preferably 30 to 70 mm. The average fiber diameter of the thermoplastic resin fiber (F1) is preferably 1 to 100 dtex, more preferably 1 to 50 dtex, particularly preferably 1 to 10 dtex. The form of the thermoplastic resin fiber (F1) may be any of a linear shape, a curved shape, a spiral shape, and the like.

The fiber mat may further contain other fibers as described above. Examples of the other fibers include fibers containing the acid-unmodified thermoplastic resin (R1-2) and melting in the press molding step (hereinafter referred to as “thermoplastic resin fiber (F2)”); fibers containing a thermoplastic resin which does not melt in the press molding step regardless of whether it is modified or not (hereinafter referred to as “high-melting-point thermoplastic resin fiber”); fibers made of a curable resin composition; and inorganic fibers. Among these, the thermoplastic resin fiber (F2) is preferred. The thermoplastic resin fiber (F2) and the high-melting-point thermoplastic resin fiber can contain various additives, like the thermoplastic resin fiber (H).

When the fiber mat contains other fibers, the upper limit on the content proportion thereof is preferably 50 parts by mass, more preferably 30 parts by mass, when the content of the thermoplastic resin fiber (F1) is 100 parts by mass.

Regardless of the presence or absence of other fibers, the proportion of the thermoplastic resin (R1) contained in the fiber mat is preferably 30 to 400 parts by mass, more preferably from 35 to 250 parts by mass, still more preferably from 40 to 150 parts by mass when the content of the vegetable fiber is 100 parts by mass.

The fiber mat is preferably composed of only one or a combination of two or more of a woven fabric, a nonwoven fabric, an airlaid web, and the like, obtained by mixing vegetable fibers, a thermoplastic resin fiber (F1), and other fibers to be used as required, and then depositing the mixture. Further, the fiber mat may be entangled by a needle punch method, a stitch bond method, a water punch method, or the like.

Although the basis weight of the fiber mat is not particularly limited, it is preferably 300 to 2000 g/m², more preferably 500 to 1800 g/m², because the vegetable fiber-containing board for obtaining a molded body excellent in rigidity can be efficiently obtained.

In the present invention, the press molding step is the step of heating and pressurizing the fiber mat from both the front and back sides at a temperature at which the thermoplastic resin fiber (F1) melts. By this hot-pressing, the thermoplastic resin fiber (F1) contained in the fiber mat melts, so that the molten resin bonds the vegetable fibers to each other. Incidentally, also when the fiber mat further contains the thermoplastic resin fiber (F2), the molten resin bonds the vegetable fibers to each other. In addition, when the fiber mat contains high-melting-point thermoplastic resin fibers, inorganic fibers, and the like, the derived molten resin such as the thermoplastic resin fiber (F1) bonds these fibers together with the vegetable fibers.

The heating temperature in the press molding step is preferably equal to or higher than the melting point of the thermoplastic resin fiber (F1), more preferably at least 5° C. higher than the melting point of the thermoplastic resin fiber (F1), particularly preferably at least 10° C. higher than the melting point of the thermoplastic resin fiber (F1) because the vegetable fibers are sufficiently bonded to each other by the molten resin. The upper limit on the heating temperature is usually 80° C. higher than the melting point of the thermoplastic resin fiber (F1).

The press pressure in the press molding step is not particularly limited, but is preferably in the range of 0.2 to 0.8 MPa, more preferably 0.25 to 0.7 MPa, particularly preferably 0.3 to 0.6 MPa, from the viewpoint of the handleability of the resulting vegetable fiber-containing board and the smoothing of suitable processing (shaping) into a substrate for an interior material. In the present invention, since the fiber mat includes the thermoplastic resin fiber (F1) containing the acid-modified thermoplastic resin having a specific acid modification degree, the press pressure is too high, so that the heated fiber mat would not stick to the press members such as hot plates constituting the producing apparatus.

In the press molding step, heating and pressurization of the fiber mat may be performed at the same time, or pressurization may be performed after heating the fiber mat. Incidentally, heating and pressurization may be repeated. Further, the press molding step may further include an operation of pressurization while cooling.

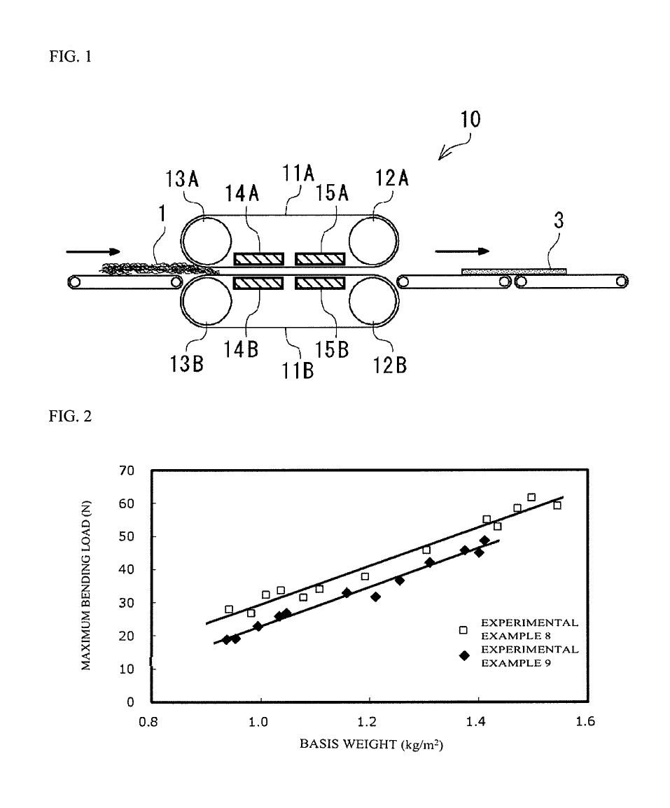

The device used in the press molding step is not particularly limited, but, because of its suitability for mass production, a double belt press device is preferred (see FIG. 1).

A double belt press device 10 in FIG. 1 is a device for supplying a fiber mat 1 from the left side of the figure to obtain a vegetable fiber-containing board 3 on the right side thereof, and includes driving rollers 12A and 12B, driven rollers 13A and 13B, a metallic belt 11A laid over between the driving roller 12A and the driven roller 13A to be in a tensioned state, and a metallic belt 11B laid over between the driving roller 12B and the driven roller 13B to be in a tensioned state. The constituent material for the metallic belts 11A and 11B is not particularly limited, and is, for example, stainless. Between the driving roller 12A and the driven roller 13A and inside the metallic belt 11A, and between the driving roller 12B and the driven roller 13B and inside the metallic belt 11B, disposed are hot pressurizing chambers 14A and 14B for hot-pressing the fiber mat 1 conveyed by the driven rollers 13A and 13B by utilizing the metallic belts 11A and 11B, and cold pressurizing chambers 15A and 15B for cold-pressing the softened fiber mat. Between the stainless belt 11A and the stainless belt 11B, an interval having a length shorter than the thickness of the supplied fiber mat 1 is provided. After cold-pressing, the vegetable fiber-containing board 3 is fed out from between the driving rollers 12A and 12B.

The heat pressurizing chambers 14A and 14B are opposed to each other in a state where the two metallic belts 11A and 11B are sandwiched therebetween. In the heat pressurizing chambers 14A and 14B, the fiber mat 1 is pressed from both the front and back sides under heating conditions in a state of being sandwiched between the metallic belts 11A and 11B. A heating medium such as heated oil is supplied into the heat pressurizing chambers 14A and 14B. Therefore, the fiber mat 1 is heated when it passes between the heat pressurizing chambers 14A and 14B. As described above, the interval between the metallic belts 11A and 11B is set to be shorter than the thickness of the supplied fiber mat 1, so that the thermoplastic resin fibers (F1) contained in the fiber mat 1 is molten, and, under pressurizing conditions, the molten resin flows through voids between the respective vegetable fibers and spreads uniformly inside the fiber mat.

On the other hand, the cold pressurizing chambers 15A and 15B are also opposed to each other in a state where the two metallic belts 11A and 11B are sandwiched, like the heat pressurizing chambers 14A and 14B. When the heated fiber mat, i.e., the heated sheet including the molten resin and the vegetable fibers, which has fed out from between the heat pressurizing chambers 14A and 14B, is introduced between the cold pressurizing chambers 15A and 15B, the heated sheet is pressed from both the front and back sides under cooling conditions in a state where it is sandwiched between the metallic belts 11A and 11B. A cooling medium such as cooling water is supplied into the cold pressurizing chambers 15A and 15B. Therefore, the heated sheet is cooled when passing between the cold pressurizing chambers 15A and 15B. The cooling temperature is not particularly limited, but is preferably 100° C. or more lower than the melting point of the thermoplastic resin having the lowest melting point among the thermoplastic resins contained in the molten resin. Then, under pressurizing conditions, the molten resin solidifies to form the vegetable fiber-containing board 3, and the vegetable fiber-containing board 3 is discharged from between the driving rollers 12A and 12B.

The present invention involves the use of a fiber mat containing a thermoplastic resin fiber (F1) containing an acid-modified thermoplastic resin having a specific acid modification degree, thereby making it possible to suppress the defect that the molten resin contained in the heated sheet sticks to the press member such as a metallic belt.

The double belt press device 10 in FIG. 1 uses the sheet-shaped fiber mat 1 as a raw material, but is not limited thereto, and may use a long fiber mat 1 as a raw material. In this case, the plate discharged from between the driving rollers 12A and 12B may be processed, by cutting or the like, into a predetermined size.

The thickness and basis weight of the vegetable fiber-containing board according to the present invention are not particularly limited. However, from the viewpoint of moldability into a substrate for an interior material particularly suitable for uses as described below, the thickness is preferably 1 to 10 mm, more preferably 1.5 to 5 mm, and the basis weight is preferably 700 to 2000 g/m², more preferably 1000 to 1500 g/m².

Another aspect of the present invention is a method for producing a substrate for an interior material, comprising the step of shaping the vegetable fiber-containing board. Specifically, the method can be a method involving heating the vegetable fiber-containing board to a temperature equal to or higher than the melting point of the thermoplastic resin contained therein to soften the board, and setting the softened board in a die molding device having a cavity having a predetermined shape to shape the board. The shaping is usually carried out by cold-pressing a softened material. The cooling temperature is preferably 100° C. or more lower than the melting point of the thermoplastic resin having the lowest melting point among the thermoplastic resins contained in the vegetable fiber-containing board.

Still another aspect of the present invention is an interior material including a base portion composed of the substrate for an interior material obtained by the above method and a skin layer disposed on a surface of the base portion.

The material constituting the skin layer is not particularly limited, and can be a synthetic leather such as a resin film, a nonwoven fabric, or the like.

Further, the base portion and the skin layer may be joined directly or may be joined with an adhesive.

### EXAMPLES

First, with reference to FIG. 1, a double belt press device 10 for a press molding step, which is used for producing a vegetable fiber-containing board, will be described.

The double belt press device 10 in FIG. 1 is a device for supplying a fiber mat 1 from the left side of the figure to obtain a vegetable fiber-containing board 3 on the right side thereof, and includes driving rollers 12A and 12B, driven rollers 13A and 13B, a stainless belt 11A laid over between the driving roller 12A and the driven roller 13A to be in a tensioned state, and a stainless belt 11B laid over between the driving roller 12B and the driven roller 13B to be in a tensioned state. Between the driving roller 12A and the driven roller 13A and inside the stainless belt 11A, and between the driving roller 12B and the driven roller 13B and inside the stainless belt 11B, disposed are hot pressurizing chambers 14A and 14B for hot-pressing the fiber mat 1 conveyed by the driven rollers 13A and 13B by utilizing the stainless belts 11A and 11B, and cold pressurizing chambers 15A and 15B for cold-pressing the softened fiber mat. After cold-pressing, the vegetable fiber-containing board 3 is fed out from between the driving rollers 12A and 12B.

Next, raw materials for producing the vegetable fiber-containing board will be indicated.
(1) Vegetable Fiber

Kenaf fibers were used.
(2) Thermoplastic Resin Fiber

After a non-modified polypropylene resin (melting point: 165° C.) and maleic anhydride-modified polypropylene resins (melting point: 100° C. to 165° C.) differing in acid modification degree were mixed at a mass ratio of 95:5, the mixtures were molten and kneaded, and spun to obtain six kinds of resin fibers (FF1) to (FF6). The degree of acid modification in the maleic anhydride-modified polypropylene resin was determined by obtaining the intensity ratio between the peak derived from the polypropylene resin (840 cm⁻¹) and the peak derived from maleic anhydride (1785 cm⁻¹) from the infrared spectrum obtained by FT-IR. For example, it was assumed that, when the absorption intensity at 840 cm⁻¹ was 0.916 and the absorption intensity at 1785 cm⁻¹ was 0.0825, the acid modification degree was 0.0825/0.916=0.090.

A resin fiber (FF0) having the above-mentioned size, obtained by spinning only the non-modified polypropylene resin, was also used.

TABLE 1

| | Acid |
|---|---|
| Thermoplastic resin | modification |
| fiber | degree |
| FF0 | 0 |
| FF1 | 0.009 |
| FF2 | 0.027 |
| FF3 | 0.045 |
| FF4 | 0.063 |
| FF5 | 0.090 |
| FF6 | 0.104 |

### Experimental Example 1

After 50 parts by mass of vegetable fibers and 50 parts by mass of a thermoplastic resin fiber (FF0) were mixed, the fiber-mixed material was laminated by the air laying method to obtain a fiber aggregate. Then, this fiber aggregate was entangled by needle punching to obtain a mat-shaped entangled material having a thickness of 8 to 12 mm. This mat-shaped entangled material was used as a fiber mat 1 (FIG. 1) for producing a vegetable fiber-containing board.

Then, the double belt press device 10 shown in FIG. 1 was driven so as to set the temperature of the heat pressurizing chambers 14A and 14B to 200° C. and the press time to 120 seconds and to set the temperature of the cold pressurizing chambers 15A and 15B to 30° C. and the press time to 180 seconds, thereby obtaining a vegetable fiber-containing board having a basis weight of 1500 g/m² and a thickness of 2.3 mm (hereinafter referred to as “vegetable fiber-containing board (BD1)”). Thereafter, when the contact surfaces of the stainless belts 11A and 11B with the fiber mat were visually observed, there was no sticking of the solidified product of the thermoplastic resin fiber (FF0) molten by hot-pressing, and the contact surfaces were in the same state as before the production.

In order to evaluate the rigidity of the obtained vegetable fiber-containing board (BD1), a test piece of 50 mm×150 mm×2.3 mm was prepared, and the maximum bending load was measured by a method according to JIS K 7171. Specifically, the test piece was supported by two fulcrums (the radius of curvature of the upper end portion was 3.2 mm) 100 mm distant from each other, and the maximum bending load when load was applied at a rate of 50 mm/min. from the point of action (the radius of curvature of the upper end portion was 3.2 mm) at the center between the fulcrums was measured to obtain 57.5 N (see Table 2).

### Experimental Example 2

A vegetable fiber-containing board having a basis weight of 1,500 g/m² and a thickness of 2.3 mm (hereinafter referred to as “vegetable fiber-containing board (BD2)”) was obtained in the same manner as in Experimental Example 1 except that the thermoplastic resin fiber (FF1) was used instead of the thermoplastic resin fiber (FF0). Thereafter, when the contact surfaces of the stainless belts 11A and 11B with the fiber mat were visually observed, there was no sticking of the solidified product of the thermoplastic resin fiber (FF1) molten by hot-pressing, and the contact surfaces were in the same state as before the production.

Then, the maximum bending load, when measured in the same manner as above, was 59.8 N (see Table 2).

### Experimental Example 3

A vegetable fiber-containing board having a basis weight of 1500 g/m² and a thickness of 2.3 mm (hereinafter referred to as “vegetable fiber-containing board (BD3)”) was obtained in the same manner as in Experimental Example 1 except that the thermoplastic resin fiber (FF2) was used instead of the thermoplastic resin fiber (FF0). Thereafter, when the contact surfaces of the stainless belts 11A and 11B with the fiber mat were visually observed, there was no sticking of the solidified product of the thermoplastic resin fiber (FF2) molten by hot-pressing, and the contact surfaces were in the same state as before the production.

Subsequently, the maximum bending load, when measured in the same manner as above, was 64.6 N (see Table 2).

### Experimental Example 4

A vegetable fiber-containing board having a basis weight of 1500 g/m² and a thickness of 2.3 mm (hereinafter referred to as “vegetable fiber-containing board (BD4)”) was obtained in the same manner as in Experimental Example 1 except that the thermoplastic resin fiber (FF3) was used instead of the thermoplastic resin fiber (FF0). Thereafter, when the contact surfaces of the stainless belts 11A and 11B with the fiber mat were visually observed, there was no sticking of the solidified product of the thermoplastic resin fiber (FF3) molten by hot-pressing, and the contact surfaces were in the same state as before the production.

Subsequently, the maximum bending load, when measured in the same manner as above, was 69.0 N (see Table 2).

### Experimental Example 5

A vegetable fiber-containing board having a basis weight of 1500 g/m² and a thickness of 2.3 mm (hereinafter referred to as “vegetable fiber-containing board (BD5)”) was obtained in the same manner as in Experimental Example 1, except that the thermoplastic resin fiber (FF4) was used instead of the thermoplastic resin fiber (FF0). Thereafter, when the contact surfaces of the stainless belts 11A and 11B with the fiber mat were visually observed, there was no sticking of the solidified product of the thermoplastic resin fiber (FF4) molten by hot-pressing, and the contact surfaces were in the same state as before the production.

Subsequently, the maximum bending load, when measured in the same manner as above, was 68.0 N (see Table 2).

### Experimental Example 6

A vegetable fiber-containing board having a basis weight of 1500 g/m² and a thickness of 2.3 mm (hereinafter referred to as “vegetable fiber-containing board (BD6)”) was obtained in the same manner as in Experimental Example 1, except that the thermoplastic resin fiber (FF5) was used instead of the thermoplastic resin fiber (FF0). Thereafter, when the contact surfaces of the stainless belts 11A and 11B with the fiber mat were visually observed, there was no sticking of the solidified product of the thermoplastic resin fiber (FF5) molten by hot-pressing, and the contact surfaces were in the same state as before the production.

Subsequently, the maximum bending load, when measured in the same manner as above, was 67.8 N (see Table 2).

### Experimental Example 7

A vegetable fiber-containing board having a basis weight of 1500 g/m² and a thickness of 2.3 mm (hereinafter referred to as “vegetable fiber-containing board (BD7)”) was obtained in the same manner as in Experimental Example 1 except that the thermoplastic resin fiber (FF6) was used instead of the thermoplastic resin fiber (FF0). Thereafter, when the contact surfaces of the stainless belts 11A and 11B with the fiber mat were visually observed, the solidified product of the thermoplastic resin fiber (FF6) molten by hot-pressing stuck to the contact surfaces.

Subsequently, the maximum bending load, when measured in the same manner as above, was 69.0 N (see Table 2).

TABLE 2

| | Thermoplastic | | | |
|---|---|---|---|---|
| | resin | Vegetable | | Maximum |
| | fiber (acid | fiber- | | bending |
| | modification | containing | Sticking to | load |
| | degree) | board | stainless belt | (N) |
| Experimental | FF0 (0) | BD1 | Not sticking | 57.5 |
| Example 1 | | | | |
| Experimental | FF1 (0.009) | BD2 | Not sticking | 59.8 |
| Example 2 | | | | |
| Experimental | FF2 (0.027) | BD3 | Not sticking | 64.6 |
| Example 3 | | | | |
| Experimental | FF3 (0.045) | BD4 | Not sticking | 69.0 |
| Example 4 | | | | |
| Experimental | FF4 (0.063) | BD5 | Not sticking | 68.0 |
| Example 5 | | | | |
| Experimental | FF5 (0.090) | BD6 | Not sticking | 67.8 |
| Example 6 | | | | |
| Experimental | FF6 (0.104) | BD7 | Sticking | 69.0 |
| Example 7 | | | | |

From Table 2, the following matter is clarified. Experimental Examples 3 to 6 are examples included in the present invention, and it was possible to smoothly produce vegetable fiber-containing boards without the thermoplastic resin sticking to the stainless belts at the time of hot-pressing. Also, the maximum bending load exceeded 64 N, indicating excellent rigidity of the vegetable fiber-containing boards. Experimental Examples 1 and 2 are examples not included in the present invention, and it was possible to smoothly produce vegetable fiber-containing boards without the thermoplastic resin sticking to the stainless belts at the time of hot-pressing. However, the adhesion to the vegetable fiber was not sufficient, and the maximum bending load did not reach 60 N. In addition, Experimental Example 7 is an example not included in the present invention, and the thermoplastic resin stuck to the stainless belts at the time of hot-pressing, so that the vegetable fiber-containing board could not be produced smoothly.

### Experimental Example 8

After 50 parts by mass of vegetable fibers and 50 parts by mass of a thermoplastic resin fiber (FF6) were mixed, the fiber-mixed material was laminated by the air laying method to obtain a plurality of kinds of fiber aggregates having a basis weight varied in the range of 0.9 to 1.6 kg/m². Then, these fiber aggregates were entangled by needle punching to obtain mat-shaped entangled materials having a thickness of 8 to 12 mm. These mat-shaped entangled materials were used as fiber mats for producing vegetable fiber-containing boards to produce vegetable fiber-containing boards (13 in total) having a thickness of 2.3 mm in the same manner as in Experimental Example 1.

Subsequently, the maximum bending load was measured in the same manner as above. Then, this is shown graphically (see FIG. 2).

### Experimental Example 9

After the non-modified polypropylene resin and a maleic anhydride-modified polypropylene resin (melting point: 160° C.) having an acid modification degree of 2.3 were mixed at a mass ratio of 95:5, the mixture was molten and kneaded, and spun to obtain a thermoplastic resin fiber (FF7).

Next, after 50 parts by mass of vegetable fibers and 50 parts by mass of the thermoplastic resin fiber (FF7) were mixed, the fiber-mixed material was laminated by the air laying method to obtain a plurality of kinds of fiber aggregates having a basis weight varied in the range of 0.9 to 1.5 kg/m². Then, these fiber aggregates were entangled by needle punching to obtain mat-shaped entangled materials having a thickness of 8 to 12 mm. These mat-shaped entangled materials were used as fiber mats for producing vegetable fiber-containing boards.

Thereafter, the double belt press device 10 shown in FIG. 1 was driven so as to set the temperature of the heat pressurizing chambers 14A and 14B to 200° C. and the press time to 120 seconds and to set the temperature of the cold pressurizing chambers 15A and 15B to 30° C. and the press time to 180 seconds, while interposing fluororesin release sheets between the fiber mat and the stainless belts, thereby obtaining vegetable fiber-containing boards (12 in total) having a thickness of 2.3 mm.

Subsequently, the maximum bending load was measured in the same manner as above. Then, this is shown graphically (see FIG. 2).

FIG. 2 shows a graph of the maximum bending load with respect to the basis weight, and approximation lines are given for Experimental Examples 8 and 9, respectively. It is clear from FIG. 2 that Experimental Example 8 included in the present invention is superior in rigidity to Experimental Example 9 not included in the present invention.

The foregoing examples are for illustrative purposes only and are not to be construed as limiting the invention. While the present invention has been described with reference to exemplary embodiments, it is understood that the words used herein are descriptive and illustrative, rather than limitative. Modifications within the scope of the appended claims may be made without departing from the scope or spirit of the invention in its form as detailed herein. Although reference has been made herein to specific structures, materials and examples in the detailed description of the present invention, the present invention is not intended to be limited to the particulars disclosed herein; rather, the present invention extends to all functionally equivalent structures, methods and uses within the scope of the appended claims.

The vegetable fiber-containing board obtained according to the present invention is widely used in the fields of vehicles, ships, airplanes, buildings, and the like, and is suitable as a precursor of interior materials, exterior materials, structural materials, and the like in these fields. Especially, it is useful for the production of an interior material in which a vegetable fiber-containing board is shaped into a substrate having a shape according to the use and then integrated with the skin material.

In the field of vehicles, it is used for automobiles, including door substrates, package trays, pillar garnishes, switch bases, quarter panels, armrest core materials, door trims, seat construction materials, console boxes, dashboards, various instrument panels, deck trims, bumpers, spoilers, and cowling.

In the field of ships or aircrafts, it is used for package trays, armrest core materials, seat structural materials, console boxes, dashboards, and various instrument panels.

Also, in the field of architecture, it is used for furniture such as covering materials and structural materials of desks, chairs, shelves, cabinets, and the like, and for houses such as door covering materials and door structural materials.

In addition, it can also be used, for example, as a package, a container (such as a tray), a protecting member, a partition member, or the like.

1. A method for producing a vegetable fiber-containing board comprising a plurality of vegetable fibers bonded to each other with a thermoplastic resin, the method comprising
heating and pressurizing a fiber mat which comprises vegetable fibers and a thermoplastic resin fiber containing a thermoplastic resin, from both front and back sides, at a temperature at which the thermoplastic resin fiber melts,
wherein the thermoplastic resin contains an acid-modified thermoplastic resin having an acid modification degree of 0.03 to 0.09.

2. The method for producing a vegetable fiber-containing board according to claim 1, wherein the acid-modified thermoplastic resin includes an acid-modified polyolefin resin.

3. A vegetable fiber-containing board comprising vegetable fibers and a thermoplastic resin bonding the vegetable fibers to each other,
wherein the thermoplastic resin contains an acid-modified thermoplastic resin having an acid modification degree of 0.03 to 0.09.

4. A method for producing a substrate for an interior material, comprising of shaping the vegetable fiber-containing board according to claim 3.

5. An interior material comprising a base portion composed of a substrate for an interior material obtained by the method according to claim 4 and a skin layer disposed on a surface of the base portion.
